(19) United States
(12) Patent Application Publication
(10) Pub. No.: US 2012/0033000 A1
(43) Pub. Date: Feb. 9, 2012

(54) DISPLAYING APPARATUS

(75) Inventors: Shuhei Takahashi, Chiba-shi (JP); Hideo Mori, Mobara-shi (JP)

(73) Assignee: CANON KABUSHIKI KAISHA, Tokyo (JP)

(21) Appl. No.: 13/182,796

(22) Filed: Jul. 14, 2011

(30) Foreign Application Priority Data
Aug. 6, 2010 (JP) 2010-177168
Jun. 28, 2011 (JP) 2011-142737

(51) Int. Cl. G09G 5/10

(52) U.S. Cl. 345/691

(57) ABSTRACT

To achieve both suppression of a flicker and high moving image performance, there is provided a displaying apparatus which comprises plural pixels each including a light-emitting element and a driving transistor for supplying a current to the light-emitting element according to gradation display data, a data line, and a light emission period control line, in which the gradation display data according to a video signal is supplied from the data line to each pixel for one frame, and a light emission period control signal is supplied from the light emission period control line, and which controls light emission of the light-emitting element based on the light emission period control signal. Here, a light emission period of one frame is a period during which the light-emitting element intermittently emits light and is a period in which luminance of the light emission period is gradually decreased.

### BACKGROUND OF THE INVENTION

1. Field of the Invention

The present invention relates to an image displaying apparatus which can perform high-quality display.

2. Description of the Related Art

In an image displaying apparatus which displays a moving image, when a period (hereinafter, called a frame period) during which a certain image signal is displayed on the image displaying apparatus is changed over to a next frame period, there are cases where blurring occurs in the moving image. It is possible to suppress the blur in the moving image by inserting a period of a black image signal before the certain frame period is changed over to the next frame period. However, in this case, when the period of the black image signal is prolonged, flickering appears.

In Japanese Patent Application Laid-Open No. 2006-030516, one frame period for light emission is divided into plural sub-frames, and each light-emitting element is caused to emit light only for a light emission time according to a duty ratio in each sub-frame, thereby suppressing flickering.

### SUMMARY OF THE INVENTION

In Japanese Patent Application Laid-Open No. 2006-030516, since a period of a black image signal to be inserted in the one frame period is shorter than that in a case where the one frame period for light emission is not divided, there is a problem that moving image performance deteriorates.

In consideration of the above problem, the present invention aims to provide a displaying apparatus which can achieve both suppression of flickering and high moving image performance.

To solve the above problem, there is provided a displaying apparatus which comprises plural pixels each including a light-emitting element and a driving transistor for supplying a current to the light-emitting element according to gradation display data, a data line, and a light emission period control line, in which the gradation display data according to a video signal is supplied from the data line to the each pixel for one frame, and a light emission period control signal is supplied from the light emission period control line, and which controls light emission of the light-emitting element based on the light emission period control signal, wherein a light emission period of the one frame is a period during which the light-emitting element intermittently emits light and is a period in which luminance of the light emission period is gradually decreased.

Moreover, there is provided a pixel driving method for a displaying apparatus which comprises plural pixels each including a light-emitting element and a driving transistor for supplying a current to the light-emitting element according to gradation display data, a data line, and a light emission period control line, the method comprising: supplying the gradation display data according to a video signal from the data line to the each pixel for one frame, supplying a light emission period control signal from the light emission period control line, and controlling light emission of the light-emitting element based on the light emission period control signal; and, in a light emission period of the one frame, causing the light-emitting element of the pixel to intermittently emit light, and gradually decreasing luminance of the light.

According to the present invention, since the light emission period of the one frame is set to the period during which the light-emitting element intermittently emits light and also to the period in which the luminance of the light emission period is gradually decreased, it is possible to achieve both the suppression of flickering and high moving image performance.

Further features of the present invention will become apparent from the following description of the exemplary embodiments with reference to the attached drawings.

### BRIEF DESCRIPTION OF THE DRAWINGS

FIG. 1 is a plan view illustrating an example of a displaying apparatus according to the present invention.

FIGS. 2A and 2B are views for describing a frame sequential pixel circuit to be used in the displaying apparatus of the present invention and a driving method of the frame sequential pixel circuit, respectively.

FIGS. 3A, 3B and 3C are views for describing a line sequential pixel circuit to be used in the displaying apparatus of the present invention, line sequential driving of an i-th line and a light emission state thereof, and line sequential driving of an (i+1)-th line and a light emission state thereof, respectively.

FIGS. 4A and 4B are views for describing differences of light emission timing in a frame sequential scanning method, and differences of light emission timing in a line sequential scanning method, respectively.

FIG. 5 is a view for describing light emission of one frame in Japanese Patent Application Laid-Open No. 2006-030516.

FIG. 6 is a view for describing light emission periods.

FIG. 7 is a view illustrating respective current-voltage characteristics of an organic EL (electroluminescence) device and a TFT (thin film transistor).

FIG. 8 is a view illustrating a circuit for outputting a signal to gradually decrease luminance in a line sequential driving circuit.

### DESCRIPTION OF THE EMBODIMENTS

Preferred embodiments of the present invention will now be described in detail in accordance with the accompanying drawings.

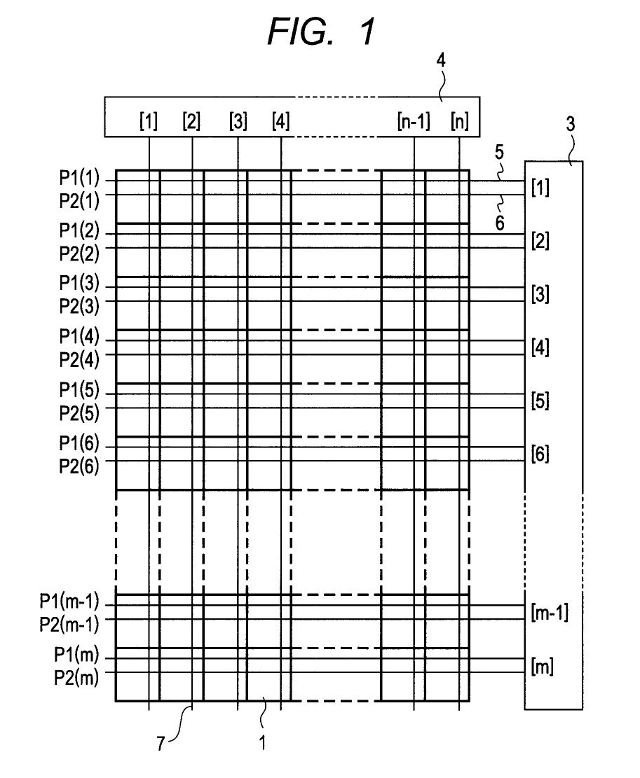

In the present invention, a displaying apparatus is an image displaying apparatus which displays a moving image, and achieves both suppression of flickering and high moving image performance by setting a light emission period of one frame to a period during which a light-emitting element intermittently emits light and also to a period in which luminance of the light emission period is gradually decreased. FIG. 1 is a plan view which illustrates an example of the displaying apparatus according to the present invention, and shows an overall constitution of the displaying apparatus.

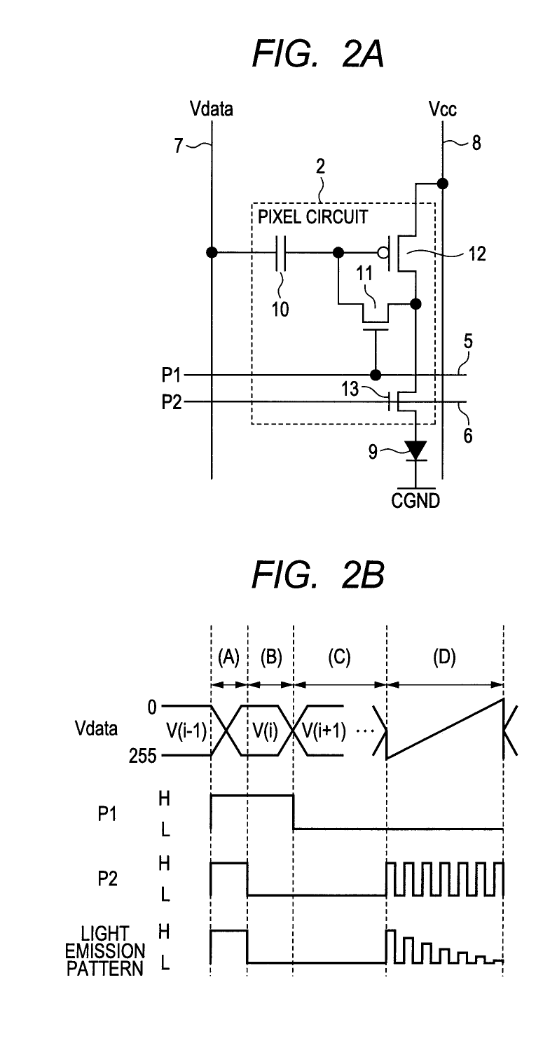

The displaying apparatus illustrated in FIG. 1 has an image displaying portion (called a “displaying area” hereinafter), where m×n (here, m and n are positive integers) pixels 1 are two-dimensionally arranged. The displaying apparatus comprises a plurality of pixels 1, a data line, and a light emission period control line, and each of the plurality of pixels 1 includes a light-emitting element corresponding to the number of RGB primary colors and a driving transistor for supplying a current to the light-emitting element according to gradation display data. The light-emitting element, the driving transistor, the data line, the control line and the like constitute a pixel circuit 2 (refer to FIG. 2A).

Control lines 5 and 6 are the light emission period control lines for supplying a light emission period control signal to each of the plurality of pixels 1 every one frame, and light emission of the light-emitting element is controlled on the basis of the light emission period control signal. A gate driving circuit 3 is connected to one end of each of the control lines 5 and 6. A control signal is input to the gate driving circuit 3 from, for example, a display panel controller (not illustrated), and plural control signals P1(1) to P1(m) and P2(1) to P2(m) for controlling an operation of the pixel circuit 2 are output from respective output terminals of the gate driving circuit 3. A control signal P1 which is one of the plural control signals output from the respective output terminals of the gate driving circuit 3 is input to the pixel circuit 2 of the each row through the control line 5, and a control signal P2 which is another control signal is input to the pixel circuit 2 of the each row through the control line 6. Although the control signals to be output from the respective output terminals of the gate driving circuit 3 are set as two signals in FIG. 1, it may not be two signals, and the number of control lines may be one line or more lines contrarily depending on the constitution of the pixel circuit.

A data line 7 supplies gradation display data according to a video signal to each of the plurality of pixels 1 every one frame. A signal driving circuit 4 is connected to one end of the data line 7. A video signal is input to the signal driving circuit 4 from, for example, the display panel controller (not illustrated), and data voltage Vdata serving as the gradation display data according to the video signal is output from respective output terminals of the signal driving circuit 4. The data voltage Vdata output from the signal driving circuit 4 is input to the pixel circuit 2 of each row through the data line 7. The signal driving circuit 4 is drawn in the vicinity of a displaying area in FIG. 1, however, the signal driving circuit 4 may be located on another substrate such as a COG (Chip-On-Glass) substrate if it is electrically connected to the displaying area.

FIG. 2A indicates an example of a pixel circuit (pixel circuit of a frame sequential scanning display method) including a self-emitting type light-emitting element preferably used in the displaying apparatus of the present invention. As a transistor to be used in the pixel circuit 2, a TFT is preferable. The control line (reset line) 5, the control line (light emission period control line) 6, the data line 7, a power line 8, an organic EL device (OLED (organic light-emitting diode) element) 9, a storage capacity portion 10, a reset TFT 11, a driving TFT 12 and a lighting TFT 13 are indicated in FIG. 2A. One end of the storage capacity portion 10 is connected to the data line 7, and the other end of the storage capacity portion 10 is connected to a gate electrode of the driving TFT 12. A gate electrode of the reset TFT 11 is connected to the control line 5, and a source electrode and a drain electrode are respectively connected to a gate electrode and a drain electrode of the driving TFT 12. One of the source electrode and the drain electrode of the driving TFT 12 is connected in series to the power line 8, and the other one is connected in series to the organic EL device 9. More properly, the source electrode of the driving TFT 12 is connected in series to the power line 8, and the drain electrode is connected in series to the organic EL device 9 through a drain electrode and a source electrode of the lighting TFT 13. A gate electrode of the lighting TFT 13 is connected to the control line 6. The reset TFT 11 and the lighting TFT 13 serving as N-channel TFTs are turned ON in a case that a signal to be entered the gate electrode is in a level H. The driving TFT 12 serving as a P-channel TFT is turned ON in a case that a signal to be entered the gate electrode is in a level L. The reset TFT 11 and the lighting TFT 13 may be the P-channel TFTs, and the driving TFT 12 may be the N-channel TFT. In the pixel circuit 2, the organic EL device is used as the light-emitting element, however, it is not limited to the organic EL device, but may be available if it is a self-emitting type light-emitting element.

FIG. 2B is a timing chart indicating a driving method of the pixel circuit illustrated in FIG. 2A, and this driving method is such a driving method in a case of performing a frame sequential scanning display.

In FIG. 2B, data voltage V(i) is written in a pixel at the same time when a threshold value of the driving TFT 12 in the pixel circuit is canceled (a history of data voltage V(i−1) is deleted) at a precharge period (A) and a writing period (B). In the period (A), since the signal P2 is in a level H at a time of a precharging operation regardless of image data, the lighting TFT 13 is closed and a current flows in the organic EL device 9, then the light is momentarily emitted. However, this light emission does not influence a gradation display. In an another line writing period (C), the data voltage is similarly written in a pixel of a line after the corresponded line at the same time when the threshold value of the driving TFT 12 is canceled. Thereafter, in a light emission period (D), the reference voltage (voltage in the data line 7) at a time of the light emission is applied to the data line 7, and a current corresponding to the current driving capacity of the driving TFT 12 is supplied to each of the organic EL devices 9 and then the light is emitted simultaneously at all the lines.

Within one frame period, a constant current corresponding to gradation display data programmed in response to the current driving capacity of the driving TFT 12 is to be supplied to the organic EL device 9 in the light emission period (D). Then, the organic EL device 9 continuously emits the light at constant luminance within one frame period like a light emission pattern indicated at a lower part in FIG. 2B.

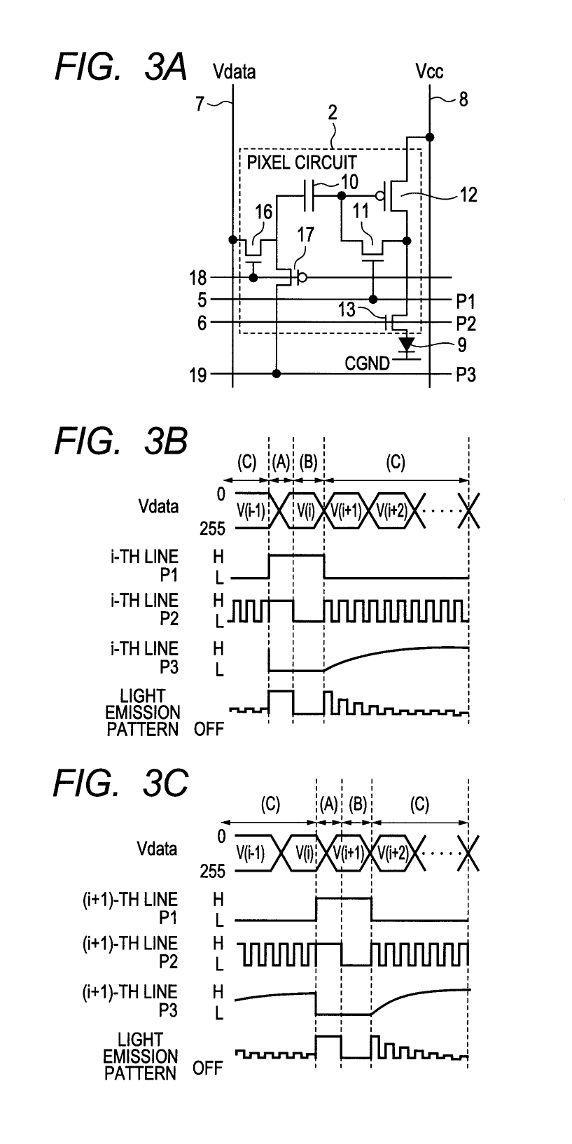

FIG. 3A indicates an example of a pixel circuit 2 (that is, a pixel circuit which adopts a line sequential scanning display method) including a self-emitting type light-emitting element preferably used in the displaying apparatus of the present invention. Here, a data line 7, a power line 8, control lines 5 (P1) and 6 (P2), a reset line 18, a reference voltage line 19 (P3), an OLED element 9, a storage capacity portion 10, a selection TFT 16, a reset TFT 17, a driving TFT 12 and a lighting TFT 13 are illustrated in FIG. 3A.

One end of the storage capacity portion 10 is connected to the data line 7 through the selection TFT 16, and the other end thereof is connected to the gate electrode of the driving TFT 12. The gate electrode of a reset TFT 11 is connected to the control line 5, and the source electrode and the drain electrode are respectively connected to the gate electrode and the drain electrode of the driving TFT 12. One of the source electrode and the drain electrode of the driving TFT 12 is connected in series to the power line 8, and the other thereof is connected in series to the organic EL device 9. More properly, the source electrode of the driving TFT 12 is connected in series to the power line 8, and the drain electrode is connected in series to the organic EL device 9 through the drain electrode and the source electrode of the lighting TFT 13. The gate electrode of the lighting TFT 13 is connected to the control line 6. The reset TFT 11 and the lighting TFT 13 serving as N-channel TFTs are turned ON in a case that a signal to be entered the gate electrode is in a level H. The driving TFT 12 serving as a P-channel TFT is turned ON in a case that a signal to be entered the gate electrode is in a level L. The reset TFT 11 and the lighting TFT 13 may be the P-channel TFTs, and the driving TFT 12 may be the N-channel TFT.

Incidentally, the organic EL device is used as the light-emitting element, however, it is not limited to the organic EL device, but may be available if it is a self-emitting type light-emitting element.

FIG. 3B indicates the driving and a light emission state of an i-th line in case of displaying white color of 255 gradations. Data voltage V(i) is written in a pixel at the same time when a threshold value of the driving TFT 12 in the pixel circuit is canceled (a history of data voltage V(i−1) is deleted) at a precharge period (A) and a writing period (B). In the period (A), since the signal P2 is in a level H at a time of a precharging operation regardless of image data, the lighting TFT 13 is closed and a current flows in the organic EL device 9, then the light is momentarily emitted. However, this light emission does not influence a gradation display. In an another line writing period (C), the data voltage is similarly written in a pixel of a line after the corresponded line at the same time when the threshold value of the driving TFT 12 is canceled. Thereafter, the reference voltage (voltage in the reference voltage line 19) at a time of the light emission is applied to the reference voltage line 19, and a current corresponding to the current driving capacity of the driving TFT 12 is supplied to the organic EL device 9. Within one frame period, a constant current corresponding to gradation display data programmed in response to the current driving capacity of the driving TFT 12 is to be supplied to the organic EL device 9 in the period (C). Then, the organic EL device 9 of an i-th line emits the light within one frame period like a light emission pattern indicated in FIG. 3B. FIG. 3C is a view indicating light emission of an (i+1)-th line next to the i-th line indicated in FIG. 3B. Incidentally, the another line writing period (C) in FIG. 3B corresponds to both the another line writing period (C) and the light emission period (D) indicated in FIG. 2B.

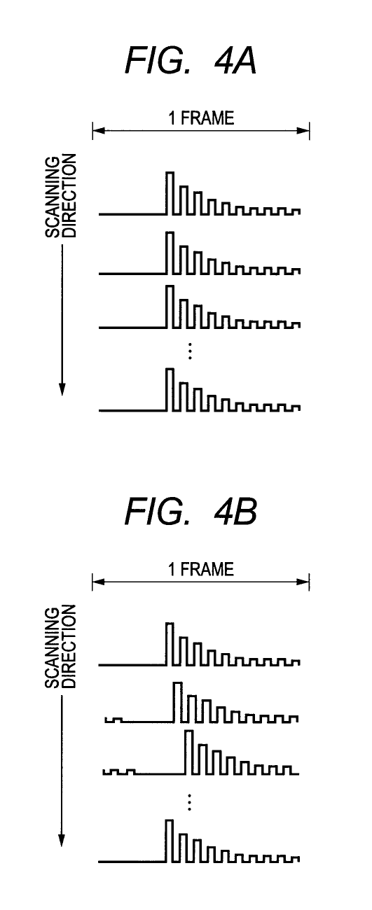

FIG. 4A is a view indicating light emitting states of respective lines in a case that the driving is performed by the frame sequential scanning to be executed by the pixel circuit indicated in FIG. 2A. FIG. 4B is a view indicating light emitting states of respective lines in a case that the driving is performed by the line sequential scanning to be executed by the pixel circuit indicated in FIG. 3A. In FIGS. 4A and 4B, patterns from a first line light emission pattern in a panel displaying area to a final line light emission pattern in the panel displaying area are indicated. A light emission period in FIG. 4A corresponds to the light emission period (D) in FIG. 2B. The light emission of an i-th line in FIG. 4B corresponds to the light emission pattern in the period (C) in FIG. 3B, and the light emission of an (i+1)-th line in FIG. 4B corresponds to the light emission pattern in the period (C) in FIG. 3C. That is, the light is emitted at all the lines simultaneously in case of a frame sequential scanning display, however, a starting time of the light emission is sequentially shifted from a first line to a final line in case of a line sequential scanning display. In FIGS. 4A and 4B, only the light emission for one frame is indicated.

### First Embodiment

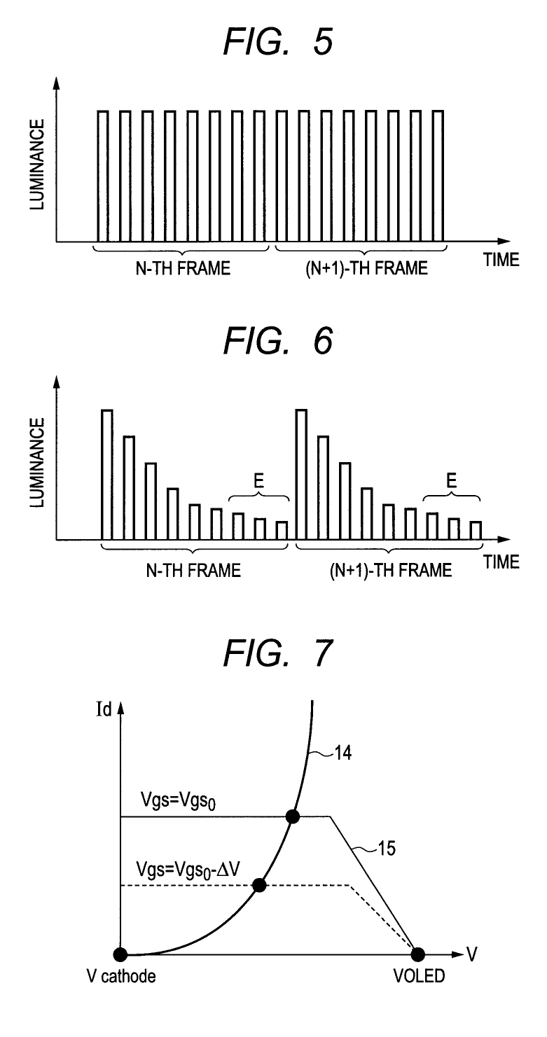

A displaying apparatus of the present embodiment is such a displaying apparatus illustrated in FIG. 1, and a pixel circuit to be arranged on each pixel is such a pixel circuit illustrated in FIG. 2A. The present embodiment will be described with reference to FIGS. 2A and 2B. First, the light emission in a frame period will be described. In Japanese Patent Application Laid-Open No. 2006-030516, the light emission is dispersed for one frame period (a period from (A) to (D) in FIG. 2B.) as illustrated in FIG. 5. On the other hand, in the present invention, a light-emitting element intermittently emits the light in a light emission period of the one frame, and the luminance of that light is gradually decreased as illustrated in FIG. 6. Incidentally, FIG. 6 indicates only the light emission period (D) in FIG. 2B or the another line writing period in FIGS. 3B and 3C.

Subsequently, a displaying method will be described. In a pixel circuit of the frame sequential scanning display method in FIG. 2A, gradation display data corresponding to a video signal is input from the data line 7, and the reference voltage is also input from the data line 7 when performing the display. Then, the lighting TFT 13 is turned ON or OFF by controlling the levels H and L of the signal P2, and the light emission period (D) of the organic EL device can be controlled. Therefore, the intermittent light emission as indicated in FIG. 2B can be realized by controlling the ON/OFF of the lighting TFT 13.

In the present embodiment, the constitution, where the luminance of a light emission period during which the light is intermittently emitted is gradually decreased in one frame period, is adopted. More specifically, the detail is as follows. The power voltage (voltage Vcc of the power line 8) is dropped by ΔV from the voltage VOLED (voltage at a time of the writing). According to this operation, a potential difference Vgs₀ between the gate voltage and the source voltage of the driving TFT 12 becomes such the voltage of Vgs₀−ΔV. In this case, if current values of operating points of the driving TFT 12 and the organic EL device are in a saturated region, since a control range of the current value is wider as compared with a case of a linear region as indicated in FIG. 7, the luminance can be controlled with a wide range. A line chart 14 in FIG. 7 indicates the current-voltage characteristic of the organic EL device and a line chart 15 in FIG. 7 indicates the current-voltage characteristic of a TFT. Therefore, the luminance of a light emission period can be gradually decreased in the one frame as indicated in FIG. 6 by changing the power voltage (voltage of the power line 8).

As described above, in the present embodiment, moving image performance can be ensured while suppressing flickering In addition, the influence of flickering, which occurs due to a fact that one frame period is constituted by only a light emission period and a light non-emission period, becomes small. Further, moving image performance is improved by changing the power voltage and changing over the luminance to the light non-emission period from the light emission period while gradually decreasing the luminance. A period E in FIG. 6 is in a state of almost black (luminance equal to or less than 1/10 of white luminance (maximum luminance)). Also, the luminance is gradually decreased in the one frame period in FIG. 6. However, it may be that the luminance is gradually decreased only in a light emission period, and this period E is set as a light non-emission period.

Further, in the present embodiment, a TFT is made to be operated in a saturated region different from a case that a linear region is treated as a region serving as operating points. Therefore, the influence of a problem of screen burn-in, which is caused by a fact that characteristic of the organic EL device is time-dependently deteriorated and the operating points are changed, is small.

### Second Embodiment

A displaying apparatus of the present embodiment and a pixel circuit to be arranged on each pixel are same as those of the first embodiment. In the present embodiment, one frame period is constituted by a light emission period during which the light is intermittently emitted and a period of which the luminance is in a state of black or almost black, similar to a case of the first embodiment. Further, in the present embodiment, such a constitution, where the luminance of a light emission period is gradually decreased, is adopted as indicated in FIG. 6. More specifically, the detail is as follows. A certain reference voltage (voltage of the data line 7) is dropped by ΔV. According to this operation, a potential difference Vgs₀ between the gate voltage and the source voltage of the driving TFT 12 becomes such the voltage of Vgs₀−ΔV. In this case, if current values of operating points of the driving TFT 12 and the organic EL device are in a saturated region, such a current characterized in that the gate voltage becomes Vgs₀−ΔV as indicated in FIG. 7 flows, and the current can be controlled. Therefore, the luminance of a light emission period can be gradually decreased in one frame period by changing the reference voltage (changing the gate voltage).

As described above, in the present embodiment, moving image performance can be ensured while suppressing flickering similar to a case of the first embodiment. In addition, the influence of flickering occurring due to a fact of momentarily changing over to a light non-emission state from a light emission state becomes small. Further, moving image performance is improved by changing the reference voltage and changing over the luminance to the light non-emission period from the light emission period while gradually decreasing the luminance. A period E in FIG. 6 is in a state of almost black (luminance equal to or less than 1/10 of white luminance (maximum luminance)). Also, the luminance is gradually decreased in one frame period in FIG. 6, however, it may be that the luminance is gradually decreased only in a light emission period and this period E is set as a light non-emission period.

In addition, in the present embodiment, the influence of a problem of screen burn-in, which is caused by a fact that characteristic of the light-emitting element is time-dependently deteriorated and the operating points are changed, is small; similar to the case of the first embodiment.

### Third Embodiment

A displaying apparatus of the present embodiment is such a displaying apparatus illustrated in FIG. 1, and a pixel circuit to be arranged on each pixel is such a pixel circuit illustrated in FIG. 3A. The present embodiment will be described with reference to FIGS. 3A to 3C.

In the pixel circuit of a line sequential scanning display method indicated in FIG. 3A, gradation display data corresponding to a video signal is input from the data line 7, and the reference voltage is input from a reference voltage line 19 when performing the display. Then, the lighting TFT 13 is turned ON or OFF by controlling the levels H and L of the lighting TFT 13, and a light emission period of the organic EL device can be controlled. Therefore, the intermittent light emission as indicated in FIG. 6 can be realized by controlling the ON/OFF of the lighting TFT 13.

In the present embodiment, the constitution, where the luminance of a light emission period during which the light is intermittently emitted is gradually decreased, is adopted. A method that the light emission of gradually decreasing the luminance is sequentially performed at each of lines will be described with reference to FIG. 6.

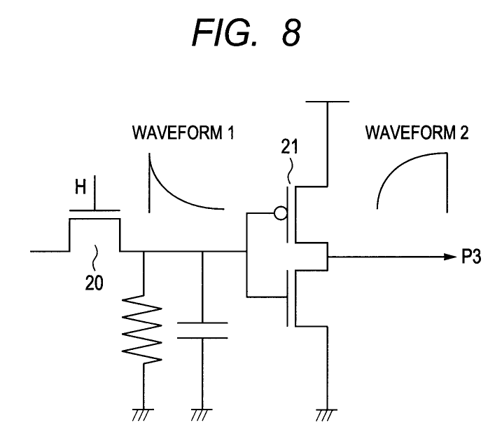

First, an H-level signal is input every one line from an external circuit capable of sequentially shifting a signal every one line through a line selection TFT 20 indicated in FIG. 8. The signal, which was input, becomes a signal of having such a waveform of attenuated as a waveform 1. This signal is inversed by an inverter circuit 21 and output to the reference voltage line (indicated as P3 in FIG. 8) as a signal of having a waveform 2. When the reference voltage is in a level H, a light-emitting display of 0-gradation is obtained, and when the reference voltage is in a level L, a light-emitting display of 255-gradation is obtained.

As described above, the influence of a flicker, which is occurred due to a fact that the one frame period is constituted by only a light emission period and a light non-emission period, becomes small and the moving image performance is more improved. In addition, in a self-emitting type line sequential driving display panel, a central part of the panel is brightly looked or a fluctuation is sensed because portions brightly looked like the belt-like shapes at upper and lower edge portions of the panel sequentially enter the eyes when the human eyes move along the scanning direction. This phenomenon is called as a saccadic eye movement, and since this eye movement occurs because the one frame period is constituted by only a light emission period and a light non-emission period, this phenomenon can be suppressed by performing the light-emitting display while gradually decreasing the luminance. A period E in FIG. 6 is in a state of almost black (luminance equal to or less than 1/10 of white luminance (maximum luminance)). Also, the luminance is gradually decreased in the one frame period in FIG. 6, however, it may be that the luminance is gradually decreased only in a light emission period and this period E is set as a light non-emission period actually.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-177168, filed Aug. 6, 2010, and Japanese Patent Application No. 2011-142737, filed Jun. 28, 2011, which are hereby incorporated by reference herein in their entirety.

1. A displaying apparatus comprising:
a plurality of pixels, wherein each pixel of said plurality of pixels includes a light-emitting element that emits light and a driving transistor that supplies a current to the light-emitting element according to gradation display data;
a data line that supplies gradation display data according to a video signal to each pixel of said plurality of pixels for one frame; and
a light emission period control line that supplies a light emission period control signal, which controls light emission of said light-emitting element,
wherein during a light emission period for one frame, said light-emitting element intermittently emits light and luminance of light emitted by said light-emitting element is gradually decreased.

2. The displaying apparatus according to claim 1 further comprising:
a power line;
wherein the driving transistor is connected in series to the power line and the light-emitting element by a source electrode and a drain electrode, and
wherein during the light emission period for one frame, the luminance of light emitted by said light-emitting element is gradually decreased by changing a voltage of the power line.

3. The displaying apparatus according to claim 2, wherein during the light emission period for one frame, the luminance of light emitted by said light-emitting element is gradually decreased by changing a gate voltage of the driving transistor.

4. A pixel driving method for a displaying apparatus which comprises a plurality of pixels, a data line, and a light emission period control line, wherein each pixel of said plurality of pixels includes a light-emitting element that emits light and a driving transistor that supplies a current to the light-emitting element, said pixel driving method comprising:
supplying gradation display data according to a video signal from the data line to each pixel of said plurality of pixels for one frame;
supplying a light emission period control signal from the light emission period control line; and
controlling light emission of the light-emitting element based on the light emission period control signal supplied from the light emission period control line,
wherein during a light emission period for one frame, said light-emitting element intermittently emit light and luminance of light emitted by the light-emitting element is gradually decreased.

5. The pixel driving method according to claim 4,
wherein the displaying apparatus further comprises a power line,
wherein the driving transistor is connected in series to the power line and light-emitting element by a source electrode and a drain electrode, and
wherein during the light emission period for one frame, the luminance of light emitted by said light-emitting element is gradually decreased by changing a voltage of the power line.

6. The pixel driving method according to claim 5, wherein during the light emission period for one frame, the luminance of light emitted by said light-emitting element is gradually decreased by changing a gate voltage of the driving transistor.
